(19) United States
(12) Patent Application Publication
(10) Pub. No.: US 2009/0292807 A1
(43) Pub. Date: Nov. 26, 2009

(54) MULTIMEDIA DATA TRANSFERRING METHOD AND SYSTEM THEREOF

(76) Inventor: Chia-Chieh LIU, Hsichih (TW)

Correspondence Address: Muncy, Geissler, Olds & Lowe, PLLC, P.O. BOX 1364, FAIRFAX, VA, 22038-1364, US

(21) Appl. No.: 12/421,026

(22) Filed: Apr. 9, 2009

(30) Foreign Application Priority Data
May 21, 2008 (TW) 97118776

(51) Int. Cl. G06F 15/173; G06F 15/16

(52) U.S. Cl. 709/225; 709/231

(57) ABSTRACT

A multimedia data transferring method includes the following steps. Receive a browsing command from a controller, wherein the controller is in a first domain. Obtain the transfer protocol and data format supported by a multimedia content item from a media server based on the browsing command, wherein the media server is in a second domain. Obtain the transfer protocol and data format supported by a media renderer, wherein the media renderer is in the first domain. Decide a desired transfer protocol and a desired data format from the transfer protocol and data format supported by multimedia content item and the media renderer. Notify the media renderer and the media server the desired transfer protocol and the desired data format. Create the data transferring connection between the media renderer and the media server based on the desired transfer protocol and data format.

### RELATED APPLICATIONS

This application claims priority to Taiwan Application Serial Number 97118776, filed May 21, 2008, which is herein incorporated by reference.

### BACKGROUND

1. Field of Invention

The present invention relates to multimedia data transferring method and system. More particularly, the present invention relates to multimedia data transferring under UPnP AV Architecture.

2. Description of Related Art

Universal Plug and Play (UPnP) is a standard defined by giant companies such as Microsoft and Intel. UPnP technology defines architecture for pervasive peer-to-peer network connectivity of intelligent appliances, wireless devices, and PCs of all form factors. It is designed to bring easy-to-use, flexible, standards-based connectivity to ad-hoc or unmanaged networks whether in the home, in a small business, public spaces, or attached to the Internet. UPnP technology provides a distributed, open networking architecture that leverages TCP/IP and the Web technologies to enable seamless proximity networking in addition to control and data transfer among networked devices.

UPnP AV is an architecture based on UPnP for pervasive peer-to-peer network connectivity. The AV Architecture defines the general interaction between UPnP Control Points and UPnP AV devices. The Control Point coordinates the operation of each device to achieve an overall, synchronized, end-user effect. Thus, a user can control a media server and a media renderer to play entertainment contents via the control point.

The UPnP AV Architecture was explicitly defined to meet the following goals: support arbitrary transfer protocols and content formats, enable the AV content to flow directly between devices without any intervention from the Control Point, and support scalability, i.e. support of devices with very low resources, especially memory and processing power.

FIG. 1 is a diagram showing a content playback scenario under UPnP AV architecture. This scenario involves three distinct UPnP components: a Media Server 170, a Media Renderer 130, and a UPnP Control Point 110. These three components (each with a well-defined role) work together to accomplish the task. The Media Server 170 contains entertainment content that the user wants to render (e.g. display or listen to) on the Media Renderer 130. The user interacts with the Control Point's UI to locate and select the desired content on the Media Server 170 and to select the target Media Renderer 130. The Control Point 110 is the only component that initiates UPnP actions. The Control Point 110 requests to configure the Media Server 170 and Media Renderer 130 so that the desired content flows from the Media Server 170 to the Media Renderer 130 using one of the transfer protocols and data formats that are supported by both the Media Server 170 and Media Renderer 130.

The Content Directory Service provides a set of actions that allow the Control Point 170 to browse or search the content the Media Server 170 can provide. The primary action of this service is Browse( ). This action allows Control Point 110 to obtain detailed information about each content item that the Server 170 can provide. This information (i.e. meta-data) includes properties such as its name, artist, date created, size, etc. Additionally, the returned meta-data identifies the transfer protocols and data formats that are supported by the Server 170 for that particular content item.

The Connection Manager Service is used to manage the connections associated with a particular device. The primary action of this service is PrepareForConnection( ). When implemented, this optional action is invoked by the Control Point 110 to give the Server 170 an opportunity to prepare itself for an upcoming transfer. When the Control Point 110 wants to terminate this connection, it should invoke the MediaServer's ConnectionComplete( ) action to release the connection. The optional AV Transport Service is used by the Control Point 110 to control the playback of the content that is associated with the specified AVTransport. This includes the ability to Stop, Pause, Seek, etc.

The Media Renderer 130 is used to render content obtained from the Media Server 170 via the network. The Media Renderer 130 includes a Rendering Control Service, a Connection Manager Service, and an optional AV Transport Service.

The Rendering Control Service provides a set of actions that allow the Control Point 110 to control how the Renderer 130 renders a piece of incoming content. This includes rendering characteristics such as brightness, contrast, volume, mute, etc. The Connection Manager Service allows the Media Renderer 130 to implement the PrepareForConnection( ) action. This action is invoked by the Control Point 110 to give the Renderer 130 an opportunity to prepare itself for an upcoming transfer. The optional AV Transport Service is used by the Control Point 110 to control the flow of the associated content. This includes the ability to Play, Stop, Pause, Seek, etc. Depending on transfer protocols and/or data formats that are supported, the Renderer 130 may or may not implement this service.

Under the UPnP AV architecture, the Control Point can only control the Media Server within the same domain. It's not doable for a user using a Renderer on the client's side to render a content item on a Media Server located in another domain.

For the foregoing reason, there is a need to provide a new data transferring method to improve this shortage.

### SUMMARY

According to one embodiment of the present invention, a multimedia data transferring method includes the following steps. Receive a browsing command from a controller, wherein the controller is in a first domain. Obtain the transfer protocol and data format supported by a multimedia content item from a media server based on the browsing command, wherein the media server is in a second domain. Obtain the transfer protocol and data format supported by a media renderer, wherein the media renderer is in the first domain. Decide a desired transfer protocol and a desired data format from the transfer protocol and data format supported by multimedia content item and the media renderer. Notify the media renderer and the media server the desired transfer protocol and the desired data format. Create the data transferring connection between the media renderer and the media server based on the desired transfer protocol and data format.

According to another embodiment of the present invention, a multimedia data transferring system includes a controller located in a first domain, a media renderer located in the first domain, a media server, a proxy, and a user interface. The media server located in a second domain provides at least one multimedia content item. The proxy located in the second domain includes means for obtaining the transfer protocol and data format supported by the multimedia content item from the media server, means for obtaining the transfer protocol and data format supported by the media renderer from the media renderer, means for deciding a desired transfer protocol and a desired data format from the transfer protocol and data format supported by the multimedia content item and the media renderer, means for notifying the media renderer and the media server the desired transfer protocol and the desired data format, and means for creating the data transferring connection between the media renderer and the media server based on the desired transfer protocol and data format. The user interface located in the second domain creates the connection between the controller and the proxy.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram showing a content playback scenario under UPnP AV architecture;

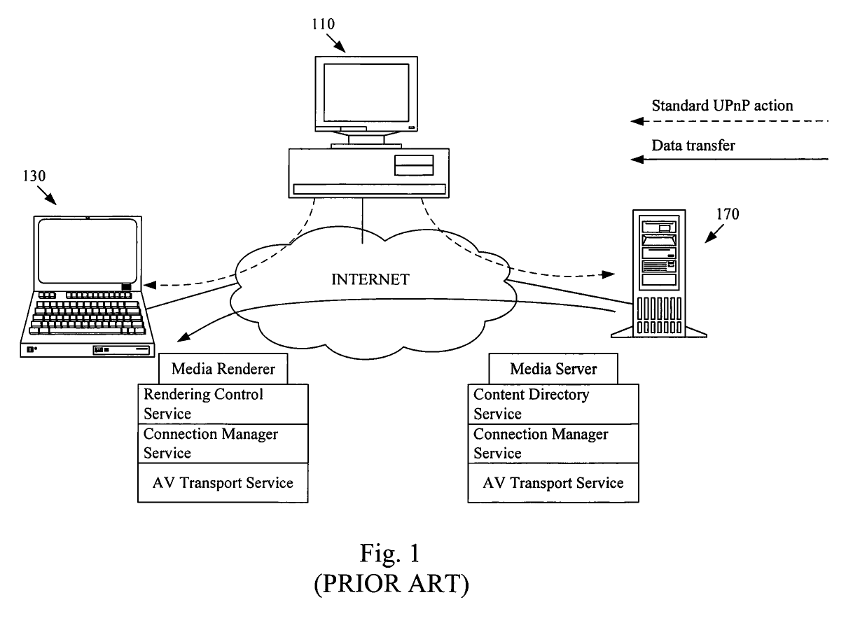

FIG. 2 is a system diagram showing multimedia data transferring according to one embodiment of this invention;

FIG. 3 is a flow chart showing the actions occurred during multimedia data transferring according to one embodiment of this invention; and

FIG. 4 is a flow chart showing the actions occurred during multimedia data transferring according to another embodiment of this invention.

### DESCRIPTION OF THE PREFERRED EMBODIMENTS

Reference will now be made in detail to the embodiment of this invention, examples of which are illustrated in the accompanying drawings. Wherever possible, the same reference numbers are used in the drawings and the description to refer to the same or like parts.

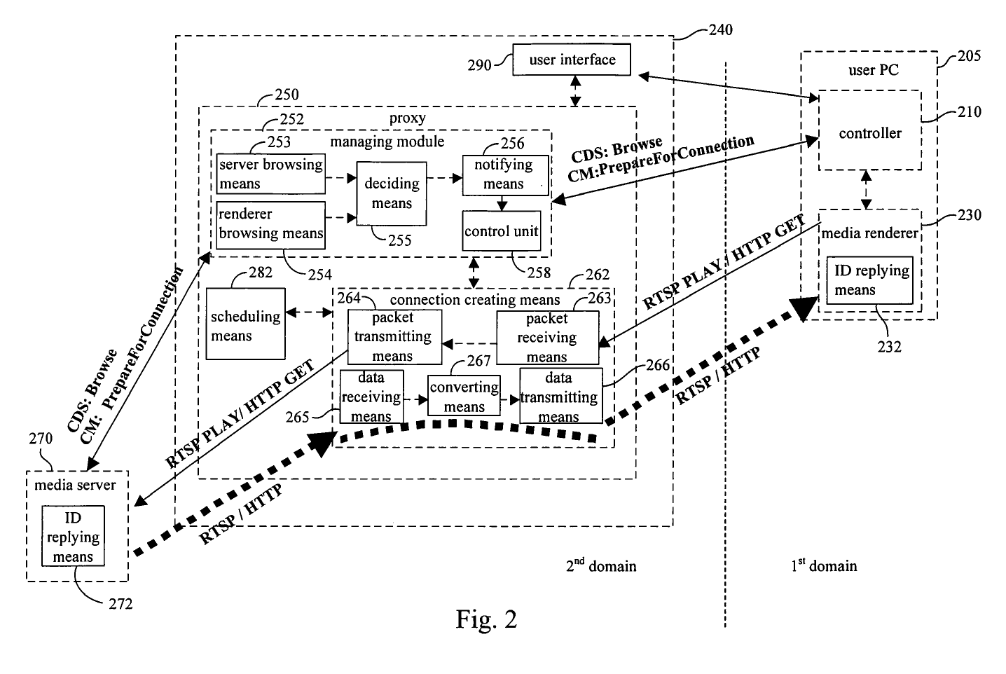

This embodiment provides a multimedia data transferring system across web domains under UPnP AV architecture. FIG. 2 is a system diagram showing multimedia data transferring according to one embodiment of this invention. The system includes a controller 210, a media renderer 230, a proxy 250, a media server 270, and a user interface 290. The controller 210 and media renderer 230 are located in a first web domain. The proxy 250, media server 270, and user interface 290 are located in a second web domain.

In this embodiment, the controller 210 and media renderer 230 are both on a user PC 205 located in the first web domain. The proxy 250 and user interface 290 are on a home server 240 located in the second web domain. The controller 210 can control the media server 270 via the proxy 250 and media renderer 230 to play entertainment content.

The media server 270 provides multimedia content items such as music, video, and pictures. The proxy 250 includes a server browsing means 253, a renderer browsing means 254, a deciding means 255, a notifying means 256, a connection creating means 262, and a scheduling means 282. The server browsing means 253, renderer browsing means 254, deciding means 255, and notifying means 256 are implanted with a managing module 252. The connection creating means 262 includes a packet receiving means 263, a packet transmitting means 264, a data receiving means 265, a data transmitting means 266, and a converting means 267.

The home server 240 provides the user interface 290 for a user to interact with in order to select a desired multimedia content item provided by the media server 270. The controller 210 obtains the home server 240's IP address, and in turn can access the proxy 250 via the user interface 290. The controller 210 can send UPnP commands to the proxy 250 and receive UPnP commands from the proxy 250. Within the managing module 252, the server browsing means 253 obtains the transfer protocol and data format supported by the desired multimedia content item from the media server 270. The renderer browsing means 254 obtains the transfer protocol and data format supported by the media renderer 230 from the media renderer 230. The deciding means 255 decides a desired transfer protocol and data format from the transfer protocol and data format supported by the media renderer and the media server.

The notifying means 256 notifies the media renderer 230 and the media server 270 the desired transfer protocol and the desired data format for data transferring. The connection creating means 262 creates the data transferring connection between the media renderer 230 and the media server 270 based on the desired transfer protocol and content format.

The media renderer 230 includes an ID replying means 232 for replying an instance ID number, and the media server 270 also includes an ID replying means 272 for replying an instance ID number. After the notifying means 256 notifies the media renderer 230 and the media server 270 the desired transfer protocol and the desired data format for data transferring, the media renderer 230 or the media server 270 replies an instance ID number based on the desired transfer protocol.

The proxy 250 also includes a control unit 258 for controlling the data transferring between the media renderer 230 and the media server 270 based on the instance ID number. The instance ID number allows the control unit 258 to control the flow of the content by invoking actions such as play, pause, stop, etc.

The connection creating means 262 includes a packet receiving means 263, packet transmitting means 264, data receiving means 265, data transmitting means 266, and converter 267. The packet receiving means 263 receives a play request packet from the media renderer 230. The packet transmitting means 264 transmits the play request packet to the media server 270 to request the media server 270 provide the desired multimedia content item. The data receiving means 265 receives the desired multimedia content item, and then the data transmitting means 266 transmits the desired multimedia content item to the media renderer 230. This completes the data transferring between the media server 270 and the media renderer 230.

In some embodiments, the converter 267 converts the multimedia content item before sends the multimedia content item to the media renderer 230 based on the transfer protocol and data format supported by the media renderer 230. For example, the converter 267 converts an RTSP (Real Time Streaming Protocol) multimedia content item to HTTP (Hypertext Transfer Protocol) multimedia content item, and after which the data transmitting means 266 sends the item via multimedia streaming to the media renderer 230 in the first domain.

Moreover, the proxy 250 further includes a scheduling means 282 for scheduling a priority when multiple play request packets are received simultaneously to require accesses to the media server 270 for multimedia content items.

This embodiment also provides a multimedia data transferring method across web domains under UPnP AV architecture. There are two categories of protocols that are commonly used when multimedia applications are transferred over the internet. One is HTTP (Hypertext Transfer Protocol), another is RTSP (Real Time Streaming Protocol), RTP (Real-time Transport Protocol), or UDP (User Datagram Protocol). The differences that might occur during data transferring will be explained below.

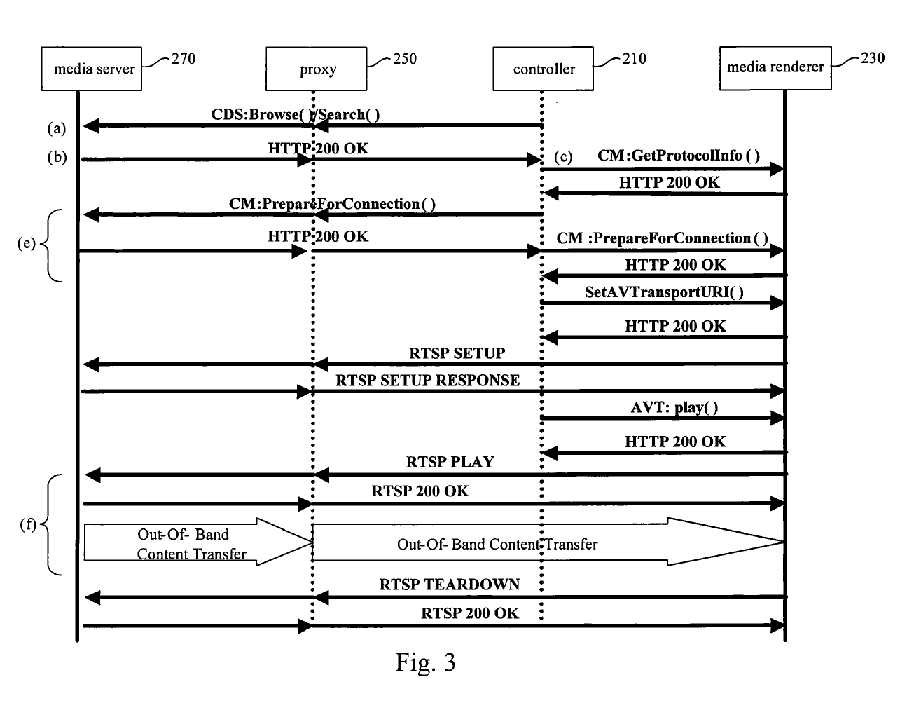

FIG. 3 is a flow chart showing the actions occurred during multimedia data transferring according to one embodiment of this invention. This embodiment shows data transferring using RTSP. The parenthesized alphabets in the figure indicate the steps below.

(a) The proxy 250 receives a browsing command from a controller 210 located in a first domain.

(b) Based on the browsing command, obtain the transfer protocol and data format supported by a multimedia content item from a media server 270 located in a second domain. The proxy 250 provides the Content Directory Service, Connection Manager Service, and optional AV Transport Service as defined under UPnP AV. So, step (a) and (b) can be done by invoking the Browse( ) or Search( ) action provided by the Content Directory Service. The message returned by the Browse( ) or Search( ) action includes detailed information about each content item.

(c) Obtain the transfer protocol and data format supported by a media renderer 230 located in the first domain. This step can be done by invoking the GetProtocolInfo( ) provided by Connection Manager Service.

(d) Decide a desired transfer protocol and a desired data format from the transfer protocol and data format supported by the multimedia content item and the media renderer 230. At this step, the controller 210 compares the transfer protocols and data formats received from the previous two steps, and then decides a desired transfer protocol and a desired data format.

(e) Notify the media renderer 230 and the media server 270 the desired transfer protocol and the desired data format for data transferring. The controller 210 invokes the PrepareForConnection( ) provided by Connection Manager Service on the media server 270 and the renderer 230 to complete this step.

(f) Based on the desired transfer protocol and data format, create the data transferring connection between the media renderer 230 and the media server 270. Based on the desired transfer protocol, the media renderer 230 or the media server 270 replies an instance ID number.

This data transferring method can also include the step of controlling the data transferring between the media renderer 230 and the media server 270 with an instance ID number. Each logical instance is bound to a particular connection between a media server and a media render. So, multiple logical instances are distinguished by their unique instance ID numbers. The instance ID number allows the controller 210 to control the flow of the content such as play, stop, and pause.

Based on the replying of the instance ID number from the media renderer 230 or the media server 270, the controller 210 invokes the SetAVTransportURI( ) action on the sender. Here the controller 210 invokes the SetAVTransportURI( ) action on the media render 230. This action notifies the renderer 230 the URI of the resource to be sent, including the internet protocol address, port number, etc. Then, the controller 210 invokes the play( ) action provided by AVTransport to obtain and play the multimedia content item.

Step (f) includes transmitting a play request packet from the media renderer 230 to the media server 270 to request the media server 270 provide the multimedia content item, and sending the multimedia content item to the media renderer 230. Additionally, this multimedia data transferring method can further include the step of scheduling a priority when multiple play request packets are received simultaneously.

In this embodiment, the proxy 250 transmits the RTSP play packet received from the media renderer 230 to the media server 270, and request the media server 270 provide the desired RTSP content item. The proxy 250 receives the desired RTSP content item, and transmits the item to the media renderer 230 for display. This completes the data transferring between the media server 270 and the media renderer 230.

Step (f) further includes the step of converting the multimedia content item based on the transfer protocol and data format supported by the media renderer. For example, based on the actual situation of the renderer 230 and the network, convert the RTSP multimedia content item to HTTP multimedia content item and send to the first domain. This completes data transferring across two domains.

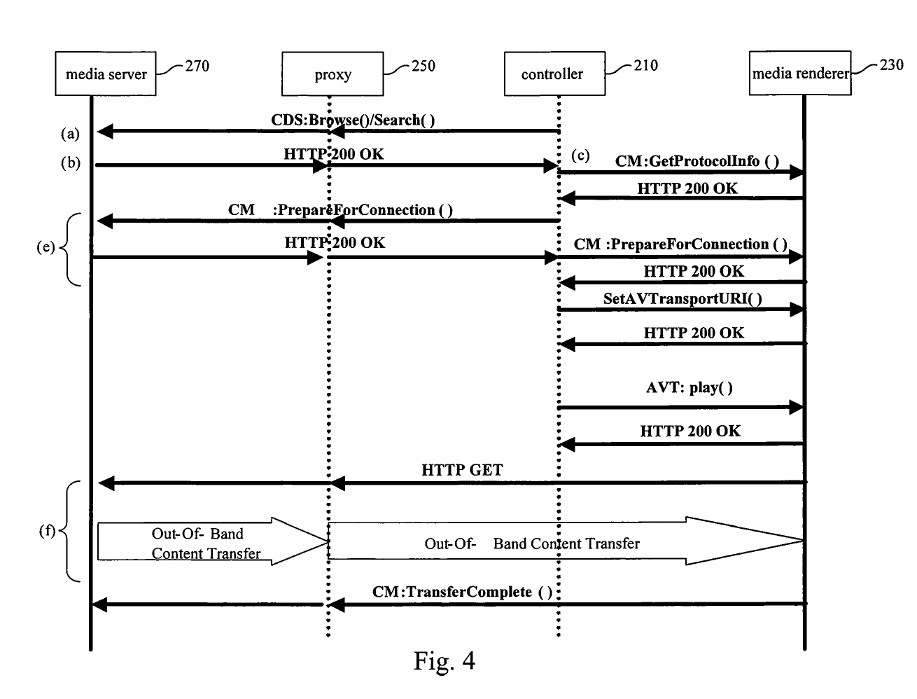

FIG. 4 is a flow chart showing the actions occurred during multimedia data transferring according to another embodiment of this invention. This embodiment shows data transferring using HTTP. The parenthesized alphabets in the figure indicate descriptions of the steps. The difference between this and the previous embodiment are described below.

The proxy 250 transmits the HTTP get packet received from the media renderer 230 to the media server 270, and request the media server 270 provide the desired HTTP content item. The proxy 250 receives the desired HTTP content item, and transmits the item to the media renderer 230 for display. The desired content item is using HTTP, and the media render 230 supports HTTP. So, there is no need for conversion.

In conclusion, the embodiment allows a renderer located in a domain to create data transferring connection with a media server in another domain via the proxy. In this way, the renderer is not restricted to playing multimedia content items located on the server in the same domain.

It will be apparent to those skilled in the art that various modifications and variations can be made to the structure of the embodiment without departing from the scope or spirit of the invention. In view of the foregoing, it is intended that the embodiment cover modifications and variations of this invention provided they fall within the scope of the following claims and their equivalents.

What is claimed is:

1. A multimedia data transferring method comprising:
a. receiving a browsing command from a controller, wherein the controller is in a first domain;
b. obtaining the transfer protocol and data format supported by a multimedia content item from a media server based on the browsing command, wherein the media server is in a second domain;
c. obtaining the transfer protocol and data format supported by a media renderer, wherein the media renderer is in the first domain;
d. deciding a desired transfer protocol and a desired data format from the transfer protocol and data format supported by the multimedia content item and the media renderer;
e. notifying the media renderer and the media server the desired transfer protocol and the desired data format; and
f. creating the data transferring connection between the media renderer and the media server based on the desired transfer protocol and data format.

2. The method of claim 1, further comprising controlling the data transferring connection between the media renderer and the media server with an instance ID number.

3. The method of claim 1, wherein the step f comprises:
transmitting a play request packet from the media renderer to the media server to request the media server provide the multimedia content item; and
sending the multimedia content item to the media renderer.

4. The method of claim 3, wherein the step f comprises:
converting the multimedia content item based on the transfer protocol and data format supported by the media renderer.

5. The method of claim 3, further comprising scheduling a priority when a plurality of the play request packets are received simultaneously.

6. A multimedia data transferring system comprising:
a controller located in a first domain;
a media renderer located in the first domain;
a media server located in a second domain for providing at least one multimedia content item;
a proxy located in the second domain, the proxy comprising:
means for obtaining the transfer protocol and data format supported by the multimedia content item from the media server;
means for obtaining the transfer protocol and data format supported by the media renderer from the media renderer;
means for deciding a desired transfer protocol and a desired data format from the transfer protocol and data format supported by the multimedia content item and the media renderer;
means for notifying the media renderer and the media server the desired transfer protocol and the desired data format; and
means for creating the data transferring connection between the media renderer and the media server based on the desired transfer protocol and data format; and
a user interface located in the second domain for creating the connection between the controller and the proxy.

7. The system of claim 6, wherein the media renderer comprises means for replying an instance ID number.

8. The system of claim 7, wherein the proxy further comprises a control unit for controlling the data transferring connection between the media renderer and the media server based on the instance ID number.

9. The system of claim 6, wherein the media server comprises means for replying an instance ID number.

10. The system of claim 9, wherein the proxy further comprises a control unit for controlling the data transferring connection between the media renderer and the media server based on the instance ID number.

11. The system of claim 6, wherein the means for creating the data transferring connection comprises:
means for receiving a play request packet from the media renderer;
means for transmitting the play request packet to the media server to request the media server provide the multimedia content item;
means for receiving the multimedia content item; and
means for transmitting the multimedia content item to the media renderer.

12. The system of claim 11, wherein the proxy further comprises means for scheduling a priority when a plurality of the play request packets are received simultaneously.

13. The system of claim 11, wherein the means for creating the data transferring connection comprises a converter for converting the multimedia content item based on the transfer protocol and data format supported by the media renderer.
